(19) United States
(12) Patent Application Publication
(10) Pub. No.: US 2026/0262633 A1
(43) Pub. Date: Sep. 10, 2026

(54) BORDEAUX MIXTURE/ORGANOSULFUR FUNGICIDE NANO-SUSPENSION DISPERSION

(71) Applicant: Ziyong ZHANG, Nanjing (CN)

(72) Inventors: Ziyong ZHANG, Nanjing (CN); Bing LIANG, Nanjing (CN)

(73) Assignee: Ziyong ZHANG, Nanjing (CN)

(21) Appl. No.: 19/664,037

(22) Filed: Apr. 30, 2026

Related U.S. Application Data
(63) Continuation of application No. PCT/CN2024/129527, filed on Nov. 2, 2024.

(30) Foreign Application Priority Data
Nov. 2, 2023 (WO) PCT/CN2023/129390
May 15, 2024 (WO) PCT/CN2024/093409

(51) Int. Cl. A01N 25/04; A01N 25/30; A01N 47/14; A01N 59/20

(52) U.S. Cl. CPC A01N 25/04; A01N 25/30; A01N 47/14; A01N 59/20

(57) ABSTRACT

The present invention belongs to the field of nano-pesticides, and particularly relates to the preparation of suspension dispersions of water-insoluble and solvent-insoluble pesticide varieties with a microparticle size of less than 100 nanometers, especially less than 50 nanometers. It provides a nano-suspension in which basic copper sulfate microparticles are suspended and dispersed within a random coil morphological structure formed by a water-soluble polymeric dispersant in water.

### CROSS-REFERENCE TO RELATED APPLICATIONS

This application is the U.S. continuation application of International Application No. PCT/CN2024/129527 filed on 2 Nov. 2024 which designated the U.S. and claims priority to Chinese Application No. PCT/CN2023/129390 and PCT/CN2024/093409 filed on 2 Nov. 2023 and 15 May 2024, respectively, the entire contents of each of which are hereby incorporated by reference.

### TECHNICAL FIELD

The present invention belongs to the field of nano-pesticides, and particularly relates to the preparation of suspension dispersions of metal-containing compound pesticides that are insoluble in water and organic solvents and have a microparticle size of less than 100 nanometers.

### BACKGROUND TECHNOLOGY

Modern agricultural production must use pesticides. Improving the formulation performance of existing pesticide varieties, increasing efficacy, reducing pesticide usage, and lessening environmental impact are of great significance for sustainable agricultural development.

An effective way to achieve pesticide reduction is to effectively reduce the microparticle size of active ingredients in pesticide formulations. For water-insoluble pesticides, reducing them to the minimum size means a few nanometers. Nano-pesticides refer to formulations where the pesticide microparticle size is on the nanoscale (1 to 100 nm). The microparticle size of traditional pesticide formulations is on the micrometer scale, ranging from a few micrometers to tens of micrometers or even larger. If the microparticle size is reduced to the nanometer scale, shrinking by a factor of a thousand, theoretically the number of microparticles can increase by a billion times, and the surface area can increase by a thousand times. The dramatic increase in the number and surface area of pesticide microparticles allows for a more uniform dispersion on leaves and broader contact with targets, enabling the efficacy to be fully exerted and improved.

On Apr. 1, 2019, the International Union of Pure and Applied Chemistry (IUPAC), on its 100th anniversary, announced the “Top Ten Chemical Innovations That Will Change the World,” with “nano-pesticides” ranking first. The reason is based on continuous global population growth, predicting the world population will approach 10 billion by 2050. To feed a massive population, it is necessary to significantly increase agricultural production while minimizing the environmental impact caused by land use, including reducing pesticide pollution and water consumption. Nano-pesticides, with their small microparticle sizes and better target absorption, will be an excellent tool for solving the main problems of traditional pesticides (environmental pollution, pesticide accumulation in organisms, and significant increases in pest resistance). Although it cannot be said to be the only path for sustainable agricultural development, it is certain that it has a smaller impact on the ecological environment and human health, making the Earth more sustainable.

Bordeaux mixture is a typical inorganic compound pesticide variety. Since its inception over a century ago, it has played a major role in the prevention and control of various plant fungal diseases. It contains no harmful impurities, is not prone to causing phytotoxicity, is resistant to rain wash, has no drug resistance, and can be compounded with certain other pesticides; it remains a widely used broad-spectrum protective fungicide today. The active ingredient of Bordeaux mixture is basic copper sulfate, whose solubility in water is extremely low, only 1.06 mg/L, and the traditional raw material used for its preparation is calcium hydroxide, whose water solubility is also very poor, resulting in a light blue viscous suspension with microparticle sizes ranging from micrometers to millimeters. For ease of use, companies prepare it as basic copper sulfate solids and process it into formulations, mainly wettable powders, and a small amount as suspension concentrates. The microparticle sizes of these formulations are all above a dozen to tens of micrometers. Like other traditional pesticide formulations, the larger pesticide microparticle size limits the improvement of Bordeaux mixture's efficacy and also causes its usage amount per unit area to be larger.

Bordeaux mixture is an ancient and widely used agricultural fungicide, primarily made by mixing copper sulfate, slaked lime (calcium hydroxide), and water. This mixture is particularly effective in preventing and controlling fungal infections on plants such as grapevines, potatoes, peach trees, apple trees, and bananas. Although Bordeaux mixture holds certain importance in organic agriculture, its use has raised some environmental concerns; the heavy application of copper-containing formulations over many years will inevitably impact and harm the ecological environment. In particular, the accumulation of its main component, copper, may cause soil and water pollution, as well as potential toxicity to some organisms in the ecosystem, such as fish and earthworms.

High concentrations of copper are used for the prevention and control of plant fungal and bacterial diseases, and it is the only product capable of controlling downy mildew caused by yellow molds. At low concentrations, copper is also an essential trace nutritional element for plants and animals. Most crops require copper as a micronutrient, and this usage is also substantial. For crops growing in acidic organic soils, the application concentration ranges between 3.4 to 6.7 kg/hectare, or 2.0 to 3.4 kg/hectare. For a rapid effect, foliar spraying at a Cu ion concentration of 8 g/L is also used. Continuing to use large amounts of copper formulations in this way to control plant diseases and as a nutritional element will inevitably cause environmental pollution and affect the health of animals and plants. Currently, developed countries worldwide are striving to reduce the usage of copper-containing formulations. European Commission Regulation (EC) 889/2008 sets copper dosages for organic farming, recommending 1 kg of copper/hectare per treatment, with a maximum of 6 kg/hectare/year. Further efforts to reduce the maximum allowable copper concentration are underway. A survey conducted in 12 European countries showed that copper usage in organic agriculture was 3,258 tons/year, which has been reduced to 52% of the allowable annual dose. China has not yet put this on the agenda, but judging from development trends, reducing the usage of copper formulations is globally imperative.

Europe has paid attention to the environmental impact of the copper components in Bordeaux mixture, especially the accumulation of copper ions in the soil and their long-term environmental effects. Because copper ions can accumulate in living organisms, most EU countries have banned the use of Bordeaux mixture, and only a few countries such as Belgium, Cyprus, France, Greece, Hungary, Italy, Malta, Portugal, Romania, and Slovenia still permit its use.

Reducing the microparticle size of copper-containing formulations to improve efficacy and reduce dosage is undoubtedly an effective way to solve the global copper pollution problem. Over the past century or so, regarding a traditional, widely-used pesticide variety with protective functions like Bordeaux mixture, people did not realize that its microparticle size affects the prevention and control effect and leads to increased dosage. With improved understanding of pesticide formulations and advancements in innovative technology, the preparation of clear and transparent Bordeaux mixtures (with microparticle sizes as small as 100 nm) at spraying concentrations has been placed on the current agenda.

No literature on the preparation of nanoscale Bordeaux mixture suspension dispersions was retrieved. Nanotechnology can be utilized to prepare copper formulations to improve the efficiency of Bordeaux mixture and reduce environmental impact. Preparing nanoparticles typically involves reducing copper or its compounds to the nanoscale; such particles may exhibit higher reactivity and better bioavailability due to their increased surface area, which can improve the environmental friendliness of Bordeaux mixture and enhance its anti-fungal efficacy.

In summary, Bordeaux mixture is an effective agricultural fungicide, but due to environmental considerations, its use is subject to certain restrictions. This makes it even more necessary to apply nanotechnology to improve its efficiency and reduce environmental impact, and the present invention represents innovative technology exploring these methods.

### PRIOR ART

A literature search retrieved the following prior art related to the present invention:
1. “Preparation of Sodium Dodecyl Sulfate-Bordeaux Mixture Composites and Their Synergistic Antibacterial Performance” (Yu Zhuanni, Yu Liangmin, Wang Qiang, Modern Chemical Industry, 2014, 34(11): 91-94) This article reported a method for preparing Bordeaux mixture using traditional techniques, with the difference being that sodium dodecyl sulfate (SDS) is added to the copper sulfate solution and poured into Ca(OH)₂ in several batches. When 0.3 g/L of SDS is added, an empty thread ball structure with a solid particle size of 3 to 5 μm is obtained, with a d(0.9) of 77.306 μm and a suspension rate of 90.1%. The differences between that technical scheme and the present invention are: (1) The SDS used in that technology is a small molecule and is a typical anionic surfactant containing sodium ions; whereas this patent application uses alkyl ether sulfates (mainly ammonium salts) and a water-soluble polymeric additive compounded with non-ionic surfactants. The former possesses the properties of both non-ionic and anionic surfactants because there is also a polyoxyethylene ether structure in the molecule. (2) The primary product prepared by that technology is a basic copper sulfate solid with a 3 to 5 μm empty thread ball structure and a d(0.9) of 77.306 μm. This patent application prepares a Bordeaux mixture nano-suspension dispersion with a microparticle size of less than 100 nm.
2. “Study on the Preparation of Nano Basic Copper Sulfate Fungicide by Homogeneous Precipitation Method” (Yi Qiushi, Agrochemicals 2001, 40(8): 20-22) The method disclosed in this technology uses copper oxide as a raw material, reacting it with ammonia water and ammonium sulfate, distilling out ammonia under strong boiling conditions to obtain a solid product, and washing it with water and ethanol to obtain solid basic copper sulfate. That technical scheme differs vastly from the content of this patent application, including the reactants used, preparation methods and conditions, and product morphology. It claims to prepare “nano-particle basic copper sulfate,” but gives no particle size data, and the scale bar on the electron micrograph of the aggregated particles is indistinguishable. It also claims, “When the prepared nano basic copper sulfate is made into a 1-5% % content in water containing a small amount of dispersant, it is highly dispersed into a near translucent state.” Judging from common knowledge of colloidal solutions, the microparticle size of the “translucent state” should be above hundreds of nanometers, or close to micrometer size. Therefore, this technology cannot obtain a nanoscale basic copper sulfate suspension in a strict sense.
3. “Development of Nano Basic Copper Sulfate Suspension Concentrate and Study on Its Mechanism of Action” (Gao Mengmeng, Master's Thesis of Shenyang Agricultural University 2021) This dissertation states that a 40% nano basic copper sulfate suspension was prepared using commercially available “nano basic copper sulfate” powder (particle size not specified) by selecting several additives and grinding process conditions, but the particle size of basic copper sulfate in the prepared sample was not provided. The size data measured for the ground samples are as follows: D50 (μm), in the range of 2.09 to 2.87 μm. Particle size distribution: <5 μm, 98.2% to 91.21%; 5 to 15 μm, 8.7% to 9.6%; >15 μm, 0.23% to 1.2%. This indicates that the technology prepared micrometer-scale basic copper sulfate, far larger than 100 nm. Therefore, the technical scheme disclosed in this thesis cannot obtain a nanoscale basic copper sulfate suspension in a strict sense.

Given the current technical reality that it is difficult to prepare nanoscale microparticles from solid basic copper sulfate, the present invention must forge a new path to prepare a transparent Bordeaux mixture nano-suspension of less than 100 nm or even less than 50 nm. This also shows that the target product prepared by the present invention involves significant technical difficulty.

### SUMMARY OF THE INVENTION

### Objectives of the Present Invention

One of the objectives of the present invention is to overcome the deficiencies of existing technologies and provide an innovative idea and new technology distinct from existing Bordeaux mixture preparation techniques—the preparation of a transparent Bordeaux mixture nano-suspension dispersion.

Traditional Bordeaux mixture is created by reacting copper sulfate and calcium hydroxide in water to produce basic copper sulfate. Because the solubility of calcium hydroxide in water is relatively low, and the solubility of basic copper sulfate in water is even lower, the finally obtained Bordeaux mixture is a light blue, viscous, turbid suspension with a large microparticle size, let alone transparent. For ease of use, commercially, the basic copper sulfate solid technical material is first prepared in a factory and then processed into a formulation. Because basic copper sulfate is insoluble in both water and organic solvents, current technology uses mechanical force for crushing and grinding to process it into wettable powders or a small number of suspension concentrate formulations. The microparticle sizes of commercially available Bordeaux mixtures are in the range of several to tens of micrometers, which leads to increased dosages.

The innovative idea and technology of the present invention involves treating copper sulfate (one of the raw materials for preparing Bordeaux mixture), pH buffer, water-soluble polymeric additive, and water together as one component. An aqueous alkaline compound solution acts as another component. Under pre-stirring, by controlling conditions such as the addition method, speed, and stirring speed, a transparent Bordeaux mixture nano-suspension dispersion is ultimately obtained. The transparent Bordeaux mixture prepared by the present invention has a microparticle size of less than 100 nm, which is at least two orders of magnitude smaller than traditional products.

Another objective of the present invention is to improve the prevention and control effect of Bordeaux mixture and expand its fungicidal spectrum, granting it a synergistic effect, and reducing the dosage of a single variety, by compounding it with a highly efficient, low-toxicity, broad-spectrum carbamate protective organosulfur fungicide (Mancozeb or Propineb), so that while obtaining the Bordeaux mixture nano-suspension dispersion, a Mancozeb (or Propineb) nano-suspension dispersion is also obtained, thereby simultaneously obtaining a Bordeaux mixture/organosulfur fungicide (Mancozeb or Propineb) nano-suspension dispersion.

Yet another objective of the present invention is to shorten the processing workflow of traditional formulations of Bordeaux mixture and organosulfur fungicides (Mancozeb or Propineb). The present invention integrates the technical material synthesis process and formulation processing into one to directly obtain a Bordeaux mixture/organosulfur fungicide nano-suspension dispersion. This method eliminates the technical material synthesis and purification process as well as the formulation processing process, saving corresponding production equipment, producing zero waste during the preparation process, and is environmentally friendly and energy-saving.

A further objective of the present invention is to provide a highly efficient Bordeaux mixture/organosulfur fungicide (Mancozeb or Propineb) nano-suspension dispersion that can be directly used for spraying operations. Due to its dramatically reduced microparticle size, the efficacy is significantly improved, which can contribute to reducing pesticide usage and lowering environmental pollution.

### Innovative Concepts of the Present Invention

The purpose of nano-pesticide research is to reduce pesticide microparticle size, improve formulation efficacy, and reduce pesticide usage. The commonly applied strategy is to dissolve the pesticide technical material in a solvent or composite solvent to form a single-molecule dispersion solution, and then prepare the solution into nano micelles, nano crystals, nano spheres, nano capsules, nano gels, and various nano carriers through different methods. But for pesticide varieties that are “insoluble in both water and organic solvents,” given the current technical level, relying solely on mechanical crushing and grinding cannot process all the pesticide down to nanoscale dimensions, much less fully achieve sizes below 100 nm.

The active ingredient of Bordeaux mixture is basic copper sulfate. This copper-containing inorganic compound possesses the property of being “insoluble in both water and organic solvents.” Therefore, preparing it into a transparent suspension dispersion with a microparticle size of less than 100 nm is currently a difficult challenge in the formulation research field.

Organosulfur fungicides (Mancozeb or Propineb) contain manganese and zinc metal ions; whether it is Mancozeb or Propineb, the property remains “insoluble in both water and organic solvents.” Preparing them separately into transparent suspension dispersions with a microparticle size of less than 100 nm is likewise a difficult challenge in the formulation research field.

Compounding Bordeaux mixture/Mancozeb (or Propineb) to separately prepare mixed nano-suspension dispersions presents an even greater difficulty. The technology of the present invention will contribute to resolving these difficult challenges.

Compounding Effect of Bordeaux Mixture and Mancozeb Bordeaux mixture is primarily made by mixing copper sulfate and slaked lime (calcium hydroxide). It is mainly used to prevent and control fungal diseases on fruit trees, grapes, and other crops, such as downy mildew and scab. Its main advantages are its broad spectrum and protective action, as well as its relatively low toxicity to the environment. Mancozeb is a compound fungicide containing three active ingredients: manganese, zinc ions, and an ethylenebisdithiocarbamate group. This compound is effective against a variety of plant pathogens, including many fungi and bacteria. Mancozeb is widely used on a variety of crops due to its broad spectrum and strong systemic action, especially in controlling some difficult-to-treat diseases.

Compounding Bordeaux mixture and Mancozeb can achieve the following effects: Enhance broad spectrum. Bordeaux mixture and Mancozeb each possess properties to control different types of diseases. Compounding them can enhance the overall disease prevention spectrum while reducing reliance on a single pesticide, thereby relieving pressure on the environment and delaying the development of drug resistance.

Synergistic effect. In some cases, mixing two pesticides may produce a synergistic effect, meaning the combined effect of the two pesticides is greater than the sum of their individual effects. Reduce resistance risk. As a copper-containing compound, Bordeaux mixture's fungicidal mechanism differs from the action mechanism of manganese, zinc elements, and the ethylenebisdithiocarbamate group in Mancozeb. This mechanistic difference helps reduce the speed and probability of pathogens developing resistance to a single-action-mechanism pesticide. Using pesticides with multiple action mechanisms can slow the development of pathogen resistance to pesticides.

The compounding ratio of Bordeaux mixture and Mancozeb depends on a variety of factors, such as region, crop type, and disease severity. Usually, the optimal dosage ratio can be determined through trials. The initial trial ratio can follow a 1:1 active ingredient usage ratio of Bordeaux mixture to Mancozeb, and then the ratio can be gradually adjusted based on the trial effect and stability testing; potential ratios include 2:1 or 1:2. The active ingredient dosage ratio for a Bordeaux mixture/Mancozeb water-dispersible granule formulation registered in China is 1.6:1.

Compounding Effect of Bordeaux Mixture and Propineb The purposes and reasons for compounding Bordeaux mixture with Propineb include: Enhance disease control effect. Bordeaux mixture is primarily used to control a variety of plant diseases caused by fungi, especially downy mildew and Phytophthora blight. Propineb, as a broad-spectrum fungicide, is also effective against many different types of fungal diseases. Increase coverage scope. Compounding them achieves complementary action for more comprehensive disease control. Each fungicide may have limitations against certain diseases when used alone; compounding them covers more diseases, thereby improving the overall prevention and control effect. Bordeaux mixture and Propineb each have a unique prevention and control spectrum. Compounding them expands the spectrum, simultaneously controlling diseases caused by different pathogens, providing farmers with more comprehensive protection. Delay the development of drug resistance. Using compounded pesticides with different mechanisms of action is an effective strategy to manage and delay the development of resistance. Bordeaux mixture's mechanism is mainly multi-point contact fungicidal action, while Propineb may act by mechanisms such as interfering with cell metabolism. This mechanistic difference helps reduce the speed and likelihood of pathogens developing resistance to a single-action-mechanism pesticide.

Compounding Bordeaux mixture with Mancozeb (or Propineb) to separately prepare Bordeaux mixture/Mancozeb and Bordeaux mixture/Propineb nano-suspension dispersions faces tremendous technical challenges. To this end, preparation methods different from conventional ones must be considered.

The innovative ideas of the present invention are as follows:

Step One, classify the raw materials used to generate the Bordeaux mixture and organosulfur fungicides separately.

The raw materials for generating Bordeaux mixture include: precursor copper sulfate, alkaline compounds (ammonium hydroxide, sodium hydroxide, potassium hydroxide), water-soluble polymeric additives, pH buffers, and water. Among these, copper sulfate and the alkali will react and must be separated into different components.

The raw materials for generating Mancozeb include: precursor dithiocarbamate salts, including Amobam, sodium ethylenebisdithiocarbamate, and potassium ethylenebisdithiocarbamate; metal salts, including manganese salts and zinc salts. Manganese salts include manganese sulfate, manganese acetate, manganese chloride, and manganese nitrate; zinc salts include zinc sulfate, zinc acetate, zinc chloride, and zinc nitrate.

The raw materials for generating Propineb include: precursor propineb salts, including ammoniumpropylenebis(dithiocarbamate) (propineb-ammonium), propineb-sodium, and propineb-potassium; the metal salt is only zinc salt, including zinc sulfate, zinc acetate, zinc chloride, and zinc nitrate. Water-soluble polymeric additives and water are ingredients used in common by all. Precursors will react with manganese and zinc salts and must be separated into different components.

Step Two, combine non-reacting ingredients and divide them into different components.

Taking a three-component scheme as an example:

Component A: Composed of the precursor of the organosulfur fungicide (such as Amobam or ammoniumpropylenebis(dithiocarbamate) (ammoniumpropylenebis(dithiocarbamate) (pro pineb-ammonium))), an alkaline compound (such as ammonium hydroxide), a buffer (such as ammonium sulfate), and water.

Component B: Composed of metal salts, including copper sulfate, manganese salt, and zinc salt, or their aqueous solutions.

Component C: Composed of one or more water-soluble polymeric additives or their aqueous solutions.

To simplify components, it can be further divided into a two-component scheme. It can be considered that Component A in the two-component scheme is equivalent to “Component A+Component C” in the three-component scheme.

Step Three, utilizing the water dilution process of pesticide formulations before use, proportionally allocate the volume of dilution water, and separately dilute Component A and Component B in the above two-component scheme into their allocated proportions of water to obtain corresponding diluted solutions.

Step Four, under pre-stirring, by controlling different addition methods and speeds, as well as stirring methods and speeds, keep the generated basic copper sulfatenanoparticles and Mancozeb (or Propineb) microparticles in the system at the nanoscale, thereby obtaining a transparent Bordeaux mixture/Mancozeb (or Propineb) nano-suspension dispersion.

To achieve this goal, the following points must be considered:

Controlling the formation speed of basic copper sulfate and Mancozeb (or Propineb) molecules and crystal nuclei, as well as the crystal growth speed, is the key to obtaining microparticles smaller than 100 nm. This involves considerations such as the selection of reaction ingredients and dosages, the type and dosage of water-soluble polymeric additives, the volume of water, the control of pH and the selection of buffers, and the dispersion and stabilization of the generated nano crystals.

Alkaline Strength and Selection of Alkaline Compounds. The alkali used in traditional Bordeaux mixture is slaked lime, i.e., calcium hydroxide, whose alkalinity is relatively weak, thus its reaction rate with copper sulfate is slow and easy to control, but its water solubility is poor (solubility is about 0.165 grams/100 grams of water), forming large particles at high concentrations, making it difficult to separate from the generated, even less water-soluble basic copper sulfate; the system ultimately forms a viscous suspension with large microparticle sizes. In addition to calcium hydroxide, alkaline compounds with higher solubility such as sodium hydroxide, potassium hydroxide, and ammonium hydroxide can also be used. The first two are strong alkalis, and their reaction rates with copper sulfate are fast. Meanwhile, the alkalinity of ammonium hydroxide is relatively weak, its reaction rate with copper sulfate is lower than the first two, and the generation rate of basic copper sulfate is relatively slow. Considering the control of the basic copper sulfate generation rate and the microparticle nucleation, crystallization, and growth rates, ammonium hydroxide is preferred as the alkaline compound.

Precursor Selection for Organosulfur Fungicides (Mancozeb or Propineb). The precursors for both include dithiocarbamate salts and propineb salts, which respectively have ammonium salts, sodium salts, and potassium salts. The present invention prefers ammonium salts. Because ammonium salts are weak base salts, their reactivity with manganese salts and zinc salts is lower than that of sodium and potassium salts. These salts are all dispersed as single molecules in water; when they meet, Mancozeb or Propineb molecules form easily. Starting the stirring before mixing begins, and by controlling the reaction conditions, nano crystals of the organosulfur fungicide can be simultaneously generated.

Selection of the Type and Dosage of Water-Soluble Polymeric Additives. Whether it is the reaction of copper sulfate and alkaline compounds to generate basic copper sulfate, or the reaction of precursor Amobam (or ammoniumpropylenebis(dithiocarbamate) (ammoniumpropylenebis(dithiocarbamate) (pro pineb-ammonium))) with manganese salts and zinc salts (or just zinc salts) to generate Mancozeb (or Propineb), because the products are insoluble in water, molecular aggregation will inevitably occur in the water to form crystal nuclei. The crystal nuclei continuously grow and ultimately precipitate out of the water. The objective of the present invention is to control the crystal size of the generated basic copper sulfate and Mancozeb (or Propineb) to be no larger than 100 nm. To prevent the crystal nuclei generated in the water from growing further, and to disperse, suspend, and stabilize them, a water-soluble polymeric additive must be added to the system. Water-soluble polymeric additives contain hydrophilic groups and can therefore dissolve in water to become colloidal solutions. The viscosity of a colloidal solution is much greater than that of a small-molecule surfactant at the same concentration, thus it provides a suspension effect. The high viscosity of water-soluble polymer solutions is due to the morphological structure of water-soluble polymers in water being different from that of small molecules. Due to their large molecular weight and long molecular chains, polymers do not possess a straight-chain structure when dissolved in water, but exist in a random coil morphological structure. This random coil is dispersed in water in a molecularly dissolved state, with sizes ranging from a few nanometers to tens or even hundreds of nanometers, mainly depending on its relative molecular mass and the flexibility of the molecular chain. This random coil has a suspension effect on the nano crystals generated in the solution; the principle lies in the random coil having a loose spatial structure, and under stirring, the extremely small basic copper sulfate crystals and Mancozeb (or Propineb) crystals generated by the reaction enter into it, thereby blocking crystal aggregation, playing a role in dispersing, suspending, and stabilizing, preventing and controlling the further growth of the crystals.

Categorizing water-soluble polymers by type, there are anionic, cationic, zwitterionic, and non-ionic types; categorizing by source, there are natural polymers and their derivatives, as well as synthetic polymers. What type of water-soluble polymeric additive to select and use, along with its dosage, can be determined through testing.

Selection of Dilution Water Volume. The amount of dilution water essentially determines the concentration of the basic copper sulfate and Mancozeb (or Propineb) nano crystals generated in the system. Theoretically, if the dilution water volume is small, the concentration of nano crystals is high, creating a greater tendency for mutual collision, crystal aggregation, and growth; the system is less stable and more prone to precipitation risks. Conversely, if the dilution water volume is large, as long as the amount of polymeric additive is sufficient, it is easier to form a transparent and stable Bordeaux mixture/Mancozeb (or Propineb) nano-suspension dispersion.

### Terminology Explanations

Dispersion System: Dispersing one or more substances into another substance constitutes a dispersion system. The substance being dispersed in a dispersion system is called the dispersed phase, and the other substance is called the dispersion medium. Based on the particle size of the dispersed phase, dispersion systems are divided into: Molecular (ionic) dispersion systems (particle size<1 nm); Colloidal dispersion systems (1 nm<particle size<100 nm).

Colloids and Sols: A colloid is a state where matter exists at a certain degree of dispersion, rather than an inherent state of a specific type of substance. Many normally insoluble substances can be dispersed in a medium under appropriate conditions to form what looks like a uniform solution, appearing no different from an ordinary true solution on the outside, but judging from aspects like diffusion speed and osmotic ability, they belong to the realm of colloidal substances, referred to as Sols.

Classification of Colloidal Solutions: Based on the stability of the colloidal solution and the structure of the colloidal particles, they are divided into: \textcircled{1} Lyophobic sols, abbreviated as Sols, which are formed by poorly soluble substances dispersed in a dispersion medium. The particles within are composed of varying numbers of molecules, possessing large phase interfaces and apparent free energy, are highly unstable, very easily destroyed and coagulate, cannot recover to their original state, and represent thermodynamically unstable and irreversible systems. \textcircled{2} Macromolecular compound solutions, whose molecular sizes have reached the colloidal range, possess colloidal properties, but are true solutions formed by molecules; they are thermodynamically stable and reversible systems, also known as Lyophilic sols.

System: The so-called system refers to the system where the alkali reacts with copper sulfate, and the manganese/zinc salts react with the precursor, under the premise of controlling the addition method, addition speed, and stirring speed when preparing the transparent basic copper sulfate, Mancozeb (or Propineb) suspension dispersion in this invention. The system is composed of substances such as copper sulfate, alkaline compounds, precursors, manganese salts, zinc salts, polymeric additives, and water.

Component: The so-called component refers to a composition containing one or more ingredients. In principle, any single ingredient used in the present invention can form a component on its own, but considering packaging, transportation, and convenience of use, the ingredients should be simplified into combinations. The principles are: \textcircled{1} ingredients do not react with each other; \textcircled{2} the number of components formed by the ingredients should not be too large.

Ingredient: The so-called ingredient refers to the raw materials used in this invention, including water-soluble precursors, copper sulfate, alkaline compounds, manganese salts, zinc salts, water-soluble polymeric additives, buffers, and water.

Water-Soluble Polymeric Additive: Refers to a macromolecular compound containing hydrophilic groups or hydrophobic backbones in the macromolecule capable of dissolving in water, also known as water-soluble polymeric surfactants or polymeric additives. Water-soluble polymeric additives can provide dispersion, suspension, emulsification, and stabilization effects. Based on group properties, they can be classified into anionic, cationic, zwitterionic, and non-ionic polymeric additives.

Microparticle Size: Also known as microparticle dimension, this primarily refers to the size of the basic copper sulfate and Mancozeb (or Propineb) microparticles generated in the system; these microparticles are usually crystalline grains and do not specifically refer to the microscopic morphological structure of the crystals.

Sub-100 Nanometer Level: This is a statistically significant classification of the pesticide microparticle size within the system. All microparticle sizes in the system exhibit a statistical distribution. The sub-100 nanometer level dispersion mentioned in the present invention means that at least 80% of the microparticles have a size smaller than this value. Microparticles larger than 100 nanometers account for only a small fraction.

Effective Stirring Speed: The so-called effective stirring speed means that under a certain addition method, when one component is added to another, through stirring at no less than the effective stirring speed, the nano crystals generated in the system can be dispersed in a timely manner without crystal growth and aggregation occurring, preventing the crystal size from growing to the multi-hundred nanometer level. The resulting system liquid presenting a transparent state is the hallmark of effective stirring.

Effective Stirring: The method and speed of adding components and stirring have a crucial impact on the resulting system liquid. Stirring methods include mechanical stirring, multi-point mechanical stirring, manual stirring, and multi-point manual stirring. Faster stirring speeds favor producing good results. If the resulting system liquid exhibits a transparent state, it is considered effective stirring. Conversely, it is considered ineffective stirring.

Pre-Stirring: When one component (the additive component) is added to another component (the base component), the relative speed of contact between the two impacts whether the nano crystals generated in the system can be dispersed in a timely manner. Pre-stirring prior to the addition of the additive component: meaning stirring the base component in advance so its rotation reaches a certain speed, can produce a good dispersion effect. Normally, the rotational speed of pre-stirring should reach or approximate the effective stirring speed.

Addition Method: The so-called addition method involves the sequence of mixing different components with water, combining them into two components. One of the two components is added to the other, or vice versa. Addition methods also include continuous addition, intermittent addition, fine stream addition, dropwise addition, spray addition, as well as addition at a fixed position or moving position. The addition method should aim for mixing and dispersion as quickly as possible.

Addition Speed: After determining the addition method, control the addition amount of the components with the goal of achieving effective stirring.

### The Key Technologies of the Present Invention Involve the Following Aspects:

### 1. Reaction to Generate Basic Copper Sulfate Nanoparticles

Copper sulfate (CuSO₄) reacting with sodium hydroxide (NaOH), potassium hydroxide (KOH), and ammonium hydroxide (NH₄OH) can all generate basic copper sulfate. From the perspectives of implementation difficulty and reaction conditions, they are divided into the following two reaction categories:

Reaction with NaOH or KOH: The reaction of CuSO₄ with NaOH or KOH is identical. They can generate either copper hydroxide or basic copper sulfate, depending on the molar ratio of the reactants. Taking potassium hydroxide as an example, the reaction formulas are respectively:

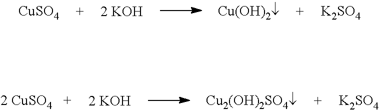

From the two reaction formulas, the important difference between generating copper hydroxide and basic copper sulfate mainly lies in the amount of alkali used. Two molecules of alkali reacting with one molecule of copper sulfate produces a copper hydroxide (Cu(OH)₂) precipitate. To form basic copper sulfate, the amount of alkali must be controlled, i.e., reducing the alkali dosage so it does not completely neutralize all copper ions in the copper sulfate, allowing some copper ions to generate in the form of basic copper sulfate. The ideal alkali dosage depends on the exact chemical formula of the basic copper sulfate desired, i.e., the ratio between the copper sulfate and alkali molecules.

Using NaOH or KOH to react with CuSO₄ to form basic copper sulfate is easy to achieve, usually proceeding at room temperature with mild reaction conditions. Because strong alkalis have high solubility in water, they can quickly react with copper sulfate to generate basic copper sulfate precipitates. But considering the goal of controlling the nanoparticle size of the product, a fast reaction speed is not a favorable factor.

Reaction with NH₄OH:

CuSO₄ reacting with NH₄OH can generate basic copper sulfate according to a reaction formula similar to the potassium hydroxide mentioned above. For example:

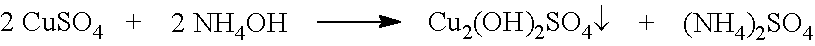

The exact chemical composition of basic copper sulfate may vary depending on reaction conditions and the ratio of reactants. As another example, a different reaction form is:

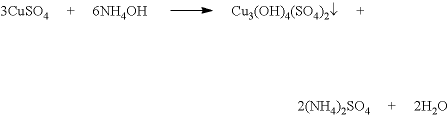

This reaction indicates that three molecules of copper sulfate react with six molecules of ammonium hydroxide to generate one molecule of basic copper sulfate, two molecules of ammonium sulfate, and water. This reaction formula is based on a specific form of basic copper sulfate; the composition of the actual product may vary due to different experimental conditions (such as reactant concentration, solution pH, temperature, etc.).

Reacting NH₄OH with CuSO₄ generates basic copper sulfate, but the process is more complex than the NaOH or KOH schemes because ammonia water (NH₄OH) is a weak base, its ability to generate basic copper sulfate is relatively weaker, requiring slightly longer time or a larger amount of alkali. Because NH₄OH is a weak base, the reaction conditions are milder, which is advantageous for controlling the formation of nano crystals.

### Comparison of the Two Reactions

NaOH and KOH are strong alkalis capable of quickly and effectively reacting with CuSO₄; while NH₄OH is a weak base with a slower reaction rate. For reactions aimed at obtaining a basic copper sulfate solid precipitate, the former has the advantage, but for desiring to obtain a nanoscale basic copper sulfate suspension dispersion, the latter reaction is undoubtedly more beneficial for control.

Considering that the objective of the present invention is to prepare a basic copper sulfate nano-suspension dispersion, the NH₄OH scheme, which features a slower reaction rate to slow down precipitate formation, is preferred. This scheme makes it easier to control crystal growth rates, facilitating the formation of nanoparticles with more uniform sizes and preventing precipitation. To further slow down the generation rate of basic copper sulfate crystals and avoid rapid crystal growth and aggregation, a pH-adjusting substance can be added to the system to lower the pH in localized regions formed when the alkali (e.g., ammonia water) is added to the system. Adding a substance that is a strong acid-weak base salt serves as a buffer, such as ammonium chloride or ammonium sulfate.

The present invention prefers a reaction scheme using copper sulfate and ammonia water as raw materials, preferably with a molecular ratio of copper sulfate to ammonia water of 1:1.

### 2. Component Ratio for the Reaction Generating Mancozeb (or Propineb)

The goal of the present invention is to prepare a Bordeaux mixture/Mancozeb (or Propineb) nano-suspension dispersion. While generating basic copper sulfate nano crystals, the system simultaneously generates Mancozeb (or Propineb) nano crystals. Their precursors are Amobam (or ammoniumpropylenebis(dithiocarbamate) (ammoniumpropylenebis(dithiocarbamate) (pro pineb-ammonium))); by reacting with appropriately proportioned manganese salts, zinc salts (or just zinc salts), the system easily generates Mancozeb (or Propineb) products. The same question remains: how to control the generation speed of Mancozeb (or Propineb) as well as the crystal growth speed, which is also a key technology for obtaining the compounded nano-suspension dispersion.

For choosing Amobam as the precursor for Mancozeb, and choosing manganese sulfate and zinc sulfate as the manganese and zinc salts, the mass ratio range is:

Amobam (generating a mass of 100 for Mancozeb):manganesesulfate:zinc sulfate=90:41-55:7-17

Preferably, Amobam:manganesesulfate:zinc sulfate=90:41-43:7-9

Further, Amobam:manganesesulfate:zinc sulfate=90:41:7

For choosing ammoniumpropylenebis(dithiocarbamate) (ammoniumpropylenebis(dithiocarbamate) (pro pineb-ammonium)) as the precursor for Propineb, and choosing zinc sulfate as the zinc salt, because ammoniumpropylenebis(dithiocarbamate) (propineb-ammonium) has two ammonium acid groups and the zinc ion is a divalent metal ion, the molecular ratio of the two should be 1:1.

Therefore, Ammoniumpropylenebis(dithiocarbamate) (propineb-ammonium) (generating a mass of 100 for Propineb):zinc sulfate=90:56.

### 3. Preparation Conditions for the Basic Copper Sulfate/Mancozeb (or Propineb) Nano-Suspension Dispersion

Preparing nanoscale basic copper sulfate is achieved by choosing the reaction of copper sulfate solution with NH₄OH solution. Preparing nanoscale Mancozeb (or Propineb) is achieved by choosing the reaction of Amobam (or ammoniumpropylenebis(dithiocarbamate) (propineb-ammonium)) with manganese salts, zinc salts (or just zinc salts). Key control factors lie in: ingredient selection, component scheme design, reactant concentrations, addition methods, stirring speeds, and the control of other reaction conditions.

After confirming the ingredients and component schemes, reaction condition control is one of the important factors. Under pre-stirring conditions, the addition method, addition speed, stirring method, and stirring speed when one component's diluted solution is added to another component's diluted solution are critical for controlling the product generation rate and crystal size. Slow dropwise addition and sufficient stirring are key to successfully obtaining the Bordeaux mixture/Mancozeb (or Propineb) nano-suspension dispersion. Secondly, the selection and dosage determination of the water-soluble polymeric additive, as well as the dilution water volume, are important guarantees for obtaining a stable nano-suspension dispersion.

### 4. Selection of Water-Soluble Polymeric Additives (Polymeric Dispersants)

When preparing the nanoscale basic copper sulfate/Mancozeb (or Propineb) nano-suspension dispersion, choosing the appropriate water-soluble polymeric additive as a dispersant to prevent precipitation and maintain a transparent state is also crucial. These substances can help stabilize nanoparticles, preventing aggregation and precipitation, thus maintaining solution transparency. The water-soluble polymeric additives chosen for the present invention include:
(1) Polyvinylpyrrolidone (PVP) and Polyvinyl alcohol (PVA) are common water-soluble synthetic polymers used as dispersants and suspending agents that can effectively stabilize various nanoparticles and prevent their aggregation. Both can prevent inter-particle aggregation by adsorbing onto the nanoparticle surfaces to form a stable protective layer.
(2) Alkyl ether sulfates (sodium salts, ammonium salts) are anionic surfactants possessing non-ionic properties, widely used for stabilizing nanoparticles. The lipophilic groups in the molecules can adsorb onto the nanoparticle surfaces, while the hydrophilic groups extend into the solution, enhancing the particle's dispersibility in water.
(3) Sodium carboxymethyl cellulose (CMC), CMC is a water-soluble cellulose derivative possessing a small number of anionic groups, capable of effectively increasing the viscosity of aqueous solutions. It improves dispersibility by forming a stable layer adsorbed onto the nanoparticle surfaces and can be used as an effective dispersant to stabilize various nano microparticles.
(4) Polyoxyethylene ethers and their derivatives are a class of non-ionic surfactants; the polyoxyethylene ether is a hydrophilic group, while the lipophilic group can be an alkyl fatty chain, alkylphenol group, arylaryl group, alkylaryl group, oleyl group, etc. It can form micelles and random coils with external hydrophilic groups and internal lipophilic groups, stabilizing nanoparticles by dispersing them within.
(5) Other anionic and non-ionic polymeric surfactants.

It should be noted that alkyl ether sulfates (sodium or ammonium salts) and sodium carboxymethyl cellulose are anionic surfactants possessing non-ionic properties, which means their molecules contain portions that can dissociate into negative charges in water.

When these anionic surfactants encounter copper ions, manganese ions, and zinc ions, they may form some type of complex. However, whether these possible products are water-soluble depends on the specific conditions and reaction ratios. But if the concentration of such additives is high enough that their hydrophilic groups can provide sufficient water solubility, this complex may also maintain a degree of water solubility. Sodium carboxymethyl cellulose is a polymeric dispersant, and its interaction with copper ions may result in copper ions forming complexes along or between the molecular chains; in this case, the water solubility of the complex mainly depends on its molecular weight, degree of substitution, and other conditions in the solution. In some instances, it can act as a stabilizer helping copper ions remain dispersed in the aqueous solution.

In conclusion, when using these polymeric additives as dispersants, it is important to determine the most suitable concentration and conditions through experiments to achieve optimal dispersion effects and solution transparency. Furthermore, the choice of dispersants should also consider the properties required by the final application field, such as whether they are biodegradable and their impact on the ecological environment. Thus, natural biodegradable polymeric additives or their derivatives are preferred types. Additionally, in certain cases, it might be necessary to use different dispersants in combination, i.e., composite additives, to achieve the best results.

### 5. Appropriate pH Range is Beneficial for Stable Nano-Particle Dispersion

The stable dispersion state of nanoparticles in an aqueous solution is affected by multiple factors, including the solution's pH value. For example, the generation and stability of basic copper sulfate nanoparticles are affected by pH. To enhance nanoparticle stability, the pH value should be adjusted into a range that maximizes the nanoparticle surface charge, which helps prevent nanoparticle aggregation through electrostatic repulsion.

Different types of nanoparticles have different pH ranges. For instance, metal oxide nanoparticles (such as TiO₂, ZnO, etc.) have better stability when the pH is far from their isoelectric point (IEP, meaning the pH value where the particle surface charge is zero). For example, TiO₂'s IEP is approximately pH 6.5, so in environments where pH<5 or pH>8, nanoparticles are usually more stable. Silver nanoparticles (Ag) typically show good stability in slightly acidic to neutral environments (pH around 5.5 to 7), because within this pH range, the surface might carry enough negative charge to promote electrostatic repulsion between particles.

For basic copper sulfate nanoparticles, the ideal pH range might be weakly acidic to weakly alkaline (approximately pH 6 to 7.5). This range is favorable for nanoparticle stability. The substance added to maintain a stable system pH is called a buffer. For an alkaline substance like basic copper sulfate, the buffer should be a strong acid-weak base salt substance, such as ammonium chloride, ammonium sulfate, etc.

### 6. Dilution Water Volume is Another Key Factor in Obtaining a Stable Nano-Suspension Dispersion

To make the basic copper sulfate/Mancozeb (or Propineb) nano-suspension dispersion transparent and stable, besides the impact of the above factors, the dilution water volume is also a key factor that needs control. High concentrations of basic copper sulfate and Mancozeb (or Propineb) are detrimental to the stable dispersion of nanoparticles. Collisions between particles will lead to particle merging, growth, and ultimately precipitation. Therefore, for a nanoparticle dispersion prepared under certain conditions at a specific concentration, there should be a certain relationship between the time frame for keeping the solution transparency stable and the volume of dilution water. Confirming this relationship must be done through experimentation.

The Bordeaux mixture/Mancozeb nano-suspension dispersion obtained by the present invention is used to prevent and control grape downy mildew and white rot; a practical example shows that 36~60/22.5~37.5 grams per mu of active ingredients are needed, respectively, with a dilution water volume of 45~75 kg, meaning the concentrations of basic copper sulfate and Mancozeb should generally be no greater than 0.08% and 0.05%, respectively.

### 7. Morphological Structure of Metal Ions in Nano-Dispersions

In the Bordeaux mixture/Mancozeb (or Propineb) nano-suspension dispersion, the morphological structures in which metal ions-including copper ions (Cu²⁺), manganese ions (Mn²⁺), and zinc ions (Zn²⁺)—exist in the system can be complex, affected by various factors including the chemical properties of the ions themselves, the system pH, and the presence of other chemicals.

All three of these ions are polyvalent metal ions. In the system, they each have three existing forms: free ions, complexes, and precipitates. Copper in Bordeaux mixture mainly exists in the form of Cu²⁺. Manganese under neutral or slightly acidic pH conditions, and zinc under most pH conditions, both exist as free Mn²⁺ and Zn²⁺ ions. When organic acids exist in the system, copper, manganese, and zinc ions can all form stable complexes. Precursors of Mancozeb (or Propineb), such as Amobam (or ammoniumpropylenebis(dithiocarbamate) (propineb-ammonium)), dissociate in water into negatively charged groups, so in principle, all three metal ions could possibly form complexes with them. Under higher pH conditions, copper, manganese, and zinc can form Cu(OH)₂, Mn(OH)₂, and Zn(OH)₂ precipitates. Since the system's pH is controlled within the 6.5~7.5 range, this situation does not occur. Therefore, the system only contains free ion and complex forms.

When compounded, interactions between ions will occur, and different metal ions might compete or influence each other, such as in ion exchange or precipitation reactions. However, regardless of the morphological structure these three metal ions present in the nano-suspension dispersion, after being sprayed onto crops, these nanoparticles are composed of the precursors forming the target products and metal ions, and all these chemical components can exert a comprehensive preventive and control effect on the diseases. Because their microparticle size has been reduced to below 100 nm, the dramatically increased number of microparticles will provide more effective prevention and control of the diseases.

### Characteristics of the Transparent Bordeaux Mixture/Mancozeb (or Propineb) Nano-Suspension Dispersion

The transparent Bordeaux mixture/Mancozeb (or Propineb) nano-suspension dispersion consists of basic copper sulfate and Mancozeb (or Propineb) nanoparticles suspended and dispersed within a random coil morphological structure formed by a water-soluble polymeric dispersant dissolved in water.

The basic copper sulfate is generated by the reaction of copper sulfate and an alkaline compound under certain conditions in the presence of a buffer. The alkaline compound is ammonium hydroxide, sodium hydroxide, or potassium hydroxide, preferably ammonium hydroxide; the buffer is a strong acid-weak base salt, preferably ammonium sulfate or ammonium chloride.

The Mancozeb is generated by the reaction of a dithiocarbamate salt precursor with manganese salts and zinc salts under certain conditions. The dithiocarbamate salt is Amobam, sodium ethylenebisdithiocarbamate, or potassium ethylenebisdithiocarbamate, preferably Amobam; the manganese salt is manganese sulfate, manganese acetate, manganese chloride, or manganese nitrate, preferably manganese sulfate; the zinc salt is zinc sulfate, zinc acetate, zinc chloride, or zinc nitrate, preferably zinc sulfate.

The Propineb is generated by the reaction of a propineb salt precursor with zinc salts under certain conditions. The propineb salt is ammoniumpropylenebis(dithiocarbamate) (propineb-ammonium), propineb-sodium, or propineb-potassium, preferably ammoniumpropylenebis(dithiocarbamate) (propineb-ammonium); the zinc salt is zinc sulfate, zinc acetate, zinc chloride, or zinc nitrate, preferably zinc sulfate.

The microparticle size of the Bordeaux mixture/Mancozeb (or Propineb) nano-suspension dispersion is at the sub-100 nanometer level.

The water-soluble polymeric dispersant existing in a random coil morphological structure can suspend, disperse, and stabilize the basic copper sulfate and Mancozeb (or Propineb) crystals.

The water-soluble polymeric dispersant existing in a random coil morphological structure is at least one of the following: Polyvinylpyrrolidone, polyvinyl alcohol, alkyl ether sulfates, sodium carboxymethyl cellulose, polyoxyethylene ethers and their derivatives, etc.

The transparent Bordeaux mixture/Mancozeb (or Propineb) nano-suspension dispersion uses pure water as the solvent. The pH range of the transparent Bordeaux mixture nano-suspension is weakly acidic to weakly alkaline. The numerical pH range for the transparent Bordeaux mixture nano-suspension is 5.5 to 8. The preferred numerical pH range is 6 to 7.5.

### Preparation Method for the Transparent Bordeaux Mixture/Mancozeb (or Propineb) Nano-Suspension Dispersion

The present invention adopts the following technical schemes: A preparation method for a transparent Bordeaux mixture/Mancozeb (or Propineb) nano-suspension dispersion.

### (1) Three-Component Scheme: Includes the Following Steps: Allocation and Preparation of Ingredients in Components

Component A: Composed of the precursor of the organosulfur fungicide Amobam (or ammoniumpropylenebis(dithiocarbamate) (propineb-ammonium)), an alkaline compound (such as ammonium hydroxide), a buffer (such as ammonium sulfate), and water. Add these ingredients into water and stir to dissolve, obtaining a transparent Component A aqueous solution.

Component B: For Bordeaux mixture/Mancozeb compounding, composed of metal salts including solids or aqueous solutions of copper sulfate, manganese salt (such as manganese sulfate), and zinc salt (such as zinc sulfate); for Bordeaux mixture/Propineb compounding, composed of metal salts including solids or aqueous solutions of copper sulfate and zinc salt (such as zinc sulfate). Component B is a solid mixture of metal salts, or a mixed aqueous solution of metal salts co-dissolved in water. Whichever method is adopted, it should follow the principle of packaging, transport simplicity, and convenience of use.

Component C: Composed of one or more water-soluble polymeric additives or their aqueous solutions.

### (2) Dilution of Components

Proportionally allocate the dilution water volume into two portions. Considering that the metal salts account for a relatively small proportion of the total component mass, the allocation principle is that Component B acts as the added component, and its dilution water volume must be far smaller than the dilution water volume of the component it is being added into.

Step one, considering that polymeric additives are more difficult to dissolve than small molecules, they should be diluted and dissolved first. Therefore, first add Component C into the allocated proportional dilution water volume, stir to dissolve, and then add Component A, stir to dissolve, obtaining a transparent mixed diluted aqueous solution of “Component A+Component C”.

Step two, dissolve Component B into the allocated proportional dilution water volume, obtaining a transparent Component B diluted aqueous solution.

### (3) Mixing and Reaction of the Two Components

At room temperature and under pre-stirring, add the Component B diluted aqueous solution into the transparent mixed diluted aqueous solution of “Component A+Component C” according to a specific addition method and stirring method.

Control the addition speed and stirring speed to achieve uniform dispersion, keeping the system continuously in a transparent state until Component B is fully added. This yields the transparent Bordeaux mixture/Mancozeb (or Propineb) nano-suspension dispersion, with a pH range of 6 to 7.5.

### Two-Component Scheme:

The preparation method is simpler than the three-component scheme. It can be considered that Component A in the two-component scheme is equivalent to “Component A+Component C” in the three-component scheme. Other dilution and mixing steps are identical.

### BRIEF DESCRIPTION OF DRAWINGS

FIG. 1: Flowchart for the preparation of Bordeaux mixture/Mancozeb nano-suspension dispersion (two components);

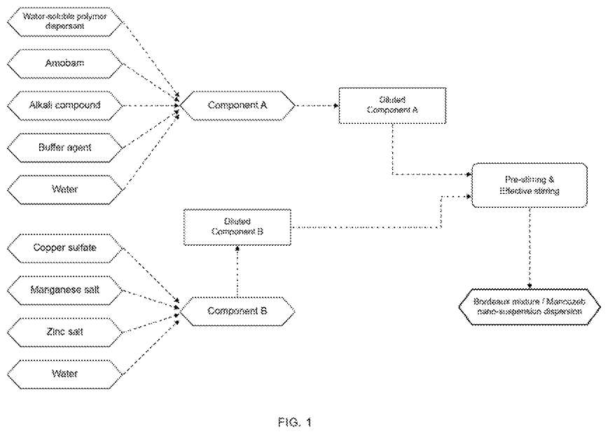

FIG. 2: Flowchart for the preparation of Bordeaux mixture/Mancozeb nano-suspension dispersion (three components);

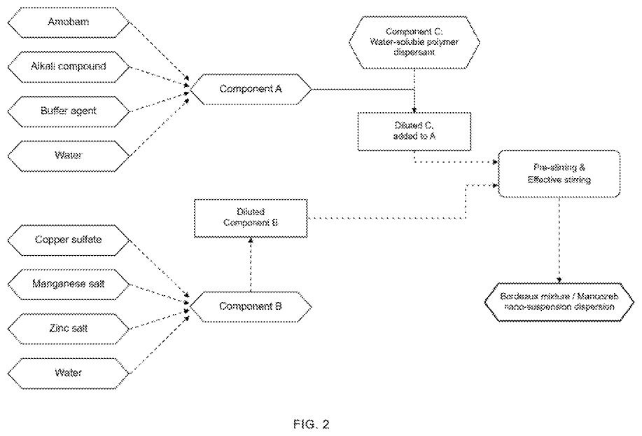

FIG. 3: Flowchart for the preparation of Bordeaux mixture/Propineb nano-suspension dispersion (two components); and

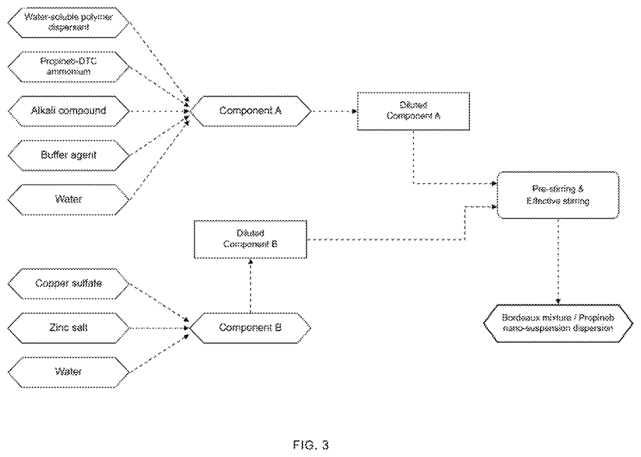

FIG. 4: Flowchart for the preparation of Bordeaux mixture/Propineb nano-suspension dispersion (three components).

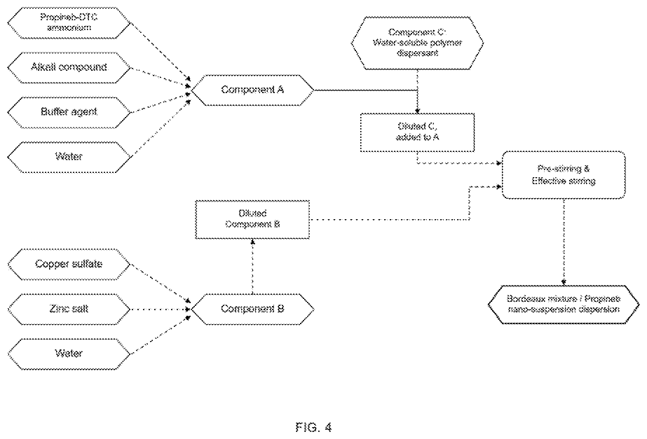

### EMBODIMENTS

### Example 1

The Bordeaux mixture/Mancozeb nano-suspension dispersion can be used to prevent and control grape downy mildew and white rot. A practical example indicates that 36~60/22.5~37.5 grams per mu of active ingredients are required, respectively, with a dilution water volume of 45~75 kilograms. Considering the high efficiency of nano-pesticides, this example uses a Bordeaux mixture/Mancozeb active ingredient dosage of 36/22 grams per mu. The dilution water volume is 45 kg.

Following the molecular ratio of the chemical reaction below:

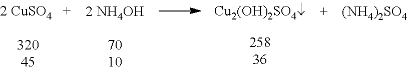

The compositional dosages for each component, proportional allocation of dilution water, and solution preparation methods are listed in the table below:

| Com- | | Mass | Total | |
|---|---|---|---|---|
| ponent | Composition | (g/mu) | (g) | Preparation |
| A | Amobam | 20 | 100 | Dilute ammonia water with |
| | Ammonia water | 36 | | water, add Amobam and |
| | (28%) | | | ammonium sulfate, stir |
| | Ammonium | 30 | | to dissolve, to obtain |
| | sulfate | | | Component A |
| | Water | 14 | | |
| B | Anhydrous copper | 45 | 55.7 | Solid mixture |
| | sulfate | | | |
| | Anhydrous | 9.1 | | |
| | manganese sulfate | | | |
| | Anhydrous zinc | 1.6 | | |
| | sulfate | | | |
| C | PVA | 25 | 1000 | Disperse PVA in water, |
| | Alkylaryl | 250 | | allow to swell overnight, |
| | polyoxypropylene | | | stir to dissolve. Add other |
| | polyoxyethylene | | | additives, stir to dissolve, |
| | ether | | | to obtain Component C |
| | Ammonium alkyl | 150 | | |
| | ether sulfate | | | |
| | Water | 575 | | |
| | Dilution water | | 45 kg | Dilution ratio of ″Com |
| | volume | | | ponent A + Component C″ |
| | | | | to Component B: 8/9 and |
| | | | | 1/9 |

### Operating Method:

(1) In a suitable container, add the allocated 8/9volume of water (40 kg), add Component C, and stir to dissolve, obtaining a transparent Component C diluted aqueous solution.
(2) Into the Component C diluted aqueous solution, add Component A, and stir to dissolve, obtaining a transparent “Component A+Component C” diluted aqueous solution.
(3) In another suitable container, add the allocated 1/9 volume of water (5 kg), add Component B, and stir to dissolve, obtaining a transparent Component B diluted aqueous solution.
(4) Under pre-stirring, use an intermittent spraying method to add the Component B diluted aqueous solution into the “Component A+Component C” diluted aqueous solution. Control the addition speed and stirring speed to ensure uniform dispersion, keeping the system continuously in a transparent state until Component B is completely added.

The resulting transparent Bordeaux mixture/Mancozeb nano-suspension dispersion can be directly used for spraying operations on grapes. Observing the stability time of the Bordeaux mixture/Mancozeb nano-suspension dispersion, the stability time is 4 hours.

### Example 2

The Bordeaux mixture/Propineb nano-suspension dispersion can be used to prevent and control alternaria leaf spot and ring rot on apple trees. Traditional wettable powder formulations of Bordeaux mixture and Propineb require 140 and 100 grams per mu of active ingredients, respectively. Considering the high efficiency of nano-pesticides, this example selects a dosage for the Bordeaux mixture/Propineb active ingredients of 60/20 grams per mu, making their usage ratio 3:1. The dilution water volume is 150 kg/mu. This example follows the molecular ratio of the chemical reaction below:

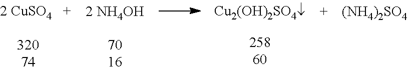

The compositional dosages for each component, proportional allocation of dilution water, and solution preparation methods are listed in the table below:

| Com- | | Mass | Total | |
|---|---|---|---|---|
| ponent | Composition | (g/mu) | (g) | Preparation |
| A | Ammoniumpropylenebis | 18 | 2000 | Add the polymeric additives |
| | (dithiocarbamate) | | | to water, stir to dissolve, then |
| | (propineb-ammonium) | | | add ammoniumpropylenebis |
| | Ammonia water (28%) | 57 | | (dithiocarbamate)(propineb- |
| | Ammonium sulfate | 50 | | ammonium), ammonium |
| | Polyoxyethylene- | 100 | | sulfate, and ammonia water, |
| | polyoxypropylene- | | | stir to dissolve, to obtain |
| | polyoxyethylene-triblock | | | Component A |
| | copolymer | | | |
| | Castor oil polyoxyethylene | 300 | | |
| | ether | | | |
| | Ammonium alkyl ether | 500 | | |
| | sulfate | | | |
| | Water | 975 | | |
| B | Anhydrous copper sulfate | 74 | 90 | Solid mixture |
| | Anhydrous zinc sulfate | 16 | | |
| | Dilution water volume | | 150 kg | Dilution ratio of Component |
| | | | | A to Component B: 14/15, |
| | | | | 1/15 |

### Operating Method:

(1) In a suitable container, add the allocated 14/15 volume of water (140 kg), add Component A, and stir to dissolve, obtaining a transparent Component A diluted aqueous solution.
(2) In another suitable container, add the allocated 1/15 volume of water (10 kg), add Component B, and stir to dissolve, obtaining a transparent Component B diluted aqueous solution.
(3) Under pre-stirring, add the Component B diluted solution via continuous spraying into the Component A diluted aqueous solution, control the addition speed and stirring speed, keeping the system continuously in a transparent state until Component B is completely added.

This yields the transparent Bordeaux mixture/Propineb nano-suspension dispersion, which can be directly used for spraying operations on apple trees. Observing the stability time of the Bordeaux mixture/Propineb nano-suspension dispersion, the stability time is 5 hours.

What is claimed is:

1. A Bordeaux mixture/Mancozeb nano-suspension dispersion, wherein the Bordeaux mixture/Mancozeb nano-suspension dispersion is a sub-100 nanometer level Bordeaux mixture/Mancozeb nano-suspension dispersion generated by mixing and reacting three components:
Component A: composed of an aqueous solution of an alkaline compound, Amobam (ammonium ethylenebisdithiocarbamate), and a buffer;
Component B: composed of solids or aqueous solutions of copper sulfate, manganese salt, and zinc salt;
Component C: composed of at least one water-soluble polymeric dispersant, or its aqueous solution;
the three components, under conditions of pre-stirring and effective stirring, generate basic copper sulfate and Mancozeb microparticles dispersed within a random coil morphological structure formed by the water-soluble polymeric dispersant dissolved in water.

2. The Bordeaux mixture/Mancozeb nano-suspension dispersion according to claim 1, characterized in that the water-soluble polymeric dispersant is at least one of the following options:
polyvinylpyrrolidone; polyvinyl alcohol; alkyl sulfates and their derivatives; sodium carboxymethyl cellulose; polyoxyethylene ether and its derivatives.

3. The Bordeaux mixture/Mancozeb nano-suspension dispersion according to claim 1, characterized in that when manganese sulfate and zinc sulfate are selected as the manganese salt and zinc salt, the mass ratio range of Amobam:manganesesulfate:zinc sulfate is:
Amobam:manganesesulfate:zinc sulfate=90:41-55:7-17;
Preferably, Amobam:manganesesulfate:zinc sulfate=90:41:7.

4. The Bordeaux mixture/Mancozeb nano-suspension dispersion according to claim 1, characterized in that the pH range of the Bordeaux mixture/Mancozeb nano-suspension dispersion is weakly acidic to weakly alkaline.

5. The Bordeaux mixture/Mancozeb nano-suspension dispersion according to claim 4, characterized in that the pH range is 6 to 7.5.

6. A Bordeaux mixture/Propineb nano-suspension dispersion, wherein the Bordeaux mixture/Propineb nano-suspension dispersion is a sub-100 nanometer level Bordeaux mixture/Propineb nano-suspension dispersion generated by mixing and reacting three components:
Component A: composed of an aqueous solution of an alkaline compound, propineb-ammonium, and a buffer;
Component B: composed of solids or aqueous solutions of copper sulfate and zinc salt;
Component C: composed of at least one water-soluble polymeric dispersant, or its aqueous solution;
the three components, under conditions of pre-stirring and effective stirring, generate basic copper sulfate and Propineb microparticles dispersed within a random coil morphological structure formed by the water-soluble polymeric dispersant dissolved in water.

7. The Bordeaux mixture/Propineb nano-suspension dispersion according to claim 6, characterized in that the water-soluble polymeric dispersant is at least one of the following options:
polyvinylpyrrolidone; polyvinyl alcohol; alkyl sulfates and their derivatives; sodium carboxymethyl cellulose; polyoxyethylene ether and its derivatives.

8. The Bordeaux mixture/Propineb nano-suspension dispersion according to claim 6, characterized in that when zinc sulfate is selected as the zinc salt, the mass ratio of propineb-ammonium to zinc sulfate is:
propineb-ammonium:zinc sulfate=90:56.

9. The Bordeaux mixture/Propineb nano-suspension dispersion according to claim 6, characterized in that the pH range of the Bordeaux mixture/Propineb nano-suspension dispersion is weakly acidic to weakly alkaline.

10. The Bordeaux mixture/Propineb nano-suspension dispersion according to claim 9, characterized in that the pH range is 6 to 7.5.

11. A preparation method for a Bordeaux mixture/Mancozeb nano-suspension dispersion, comprising the following steps:
the diluted solution of Component A is pre-stirred first, and then under conditions where the stirring speed is not less than the effective stirring speed, the diluted solution of Component B is added into the diluted solution of Component A to form a Bordeaux mixture/Mancozeb nano-suspension dispersion;
alternatively, the diluted solution of Component B is pre-stirred first, and then under conditions where the stirring speed is not less than the effective stirring speed, the diluted solution of Component A is added into the diluted solution of Component B to form a Bordeaux mixture/Mancozeb nano-suspension dispersion;
Component A: an aqueous solution composed of an alkaline compound, Amobam, a water-soluble polymeric dispersant, and water;
Component B: solids of copper sulfate, manganese salt, and zinc salt, or aqueous solutions of copper sulfate, manganese salt, and zinc salt;
the generated basic copper sulfate and Mancozeb microparticles are dispersed within the random coil morphological structure formed by the water-soluble polymeric dispersant dissolved in water.

12. The preparation method according to claim 11, further comprising the following step:
Checking the pH value of the resulting Bordeaux mixture/Mancozeb nano-suspension dispersion, and adjusting it to be weakly acidic to weakly alkaline.

13. A preparation method for a Bordeaux mixture/Propineb nano-suspension dispersion, comprising the following steps:
the diluted solution of Component A is pre-stirred first, and then under conditions where the stirring speed is not less than the effective stirring speed, the diluted solution of Component B is added into the diluted solution of Component A to form a Bordeaux mixture/Propineb nano-suspension dispersion;
alternatively, the diluted solution of Component B is pre-stirred first, and then under conditions where the stirring speed is not less than the effective stirring speed, the diluted solution of Component A is added into the diluted solution of Component B to form a Bordeaux mixture/Propineb nano-suspension dispersion;
Component A: An aqueous solution composed of an alkaline compound, propineb-ammonium, a water-soluble polymeric dispersant, and water;
Component B: Solids of copper sulfate and zinc salt, or aqueous solutions of copper sulfate and zinc salt;
the generated basic copper sulfate and Propineb microparticles are dispersed within the random coil morphological structure formed by the water-soluble polymeric dispersant dissolved in water.

14. The preparation method according to claim 13, further comprising the following step:
Checking the pH value of the resulting Bordeaux mixture/Propineb nano-suspension dispersion, and adjusting it to be weakly acidic to weakly alkaline.
